(19) United States
(12) Patent Application Publication
(10) Pub. No.: US 2024/0030476 A1
(43) Pub. Date: Jan. 25, 2024

(54) STACK DRAINAGE FOR REDOX FLOW BATTERY

(71) Applicant: KEMIWATT, Rennes (FR)

(72) Inventors: Jérémy ALLIX, Rennes (FR); Kevin PAVEC, Servon sur Vilaine (FR)

(21) Appl. No.: 18/255,088

(22) PCT Filed: Nov. 30, 2021
(86) PCT No.: PCT/EP2021/083565

§ 371 Date: May 30, 2023

(30) Foreign Application Priority Data
Nov. 30, 2020 (FR) 2012417

(51) Int. Cl. H01M 8/18; H01M 8/04276; H01M 8/0289; H01M 8/0444; H01M 8/04746; H01M 8/043

(52) U.S. Cl. CPC H01M 8/188; H01M 8/04276; H01M 8/0289; H01M 8/04477; H01M 8/04746; H01M 8/043

(57) ABSTRACT

A system includes one or more redox flow batteries and includes a stack of several electrochemical cells. The electrochemical cells include a cathode compartment and an anode compartment. The cathode compartment is in fluidic communication, via a feed circuit, with one or more tanks of electrolyte called catholyte. The anode compartment is in fluidic communication, via a feed circuit, with one or more tanks of electrolyte called anolyte. The feed circuit of the catholyte, respectively the anolyte, includes a pump for circulating the catholyte, respectively the anolyte, from the tank to the cathode, respectively the anode compartments. The system includes a catholyte drainage pump and an anolyte drainage pump, the catholyte, respectively. The anolyte drainage pump is controlled by a catholyte, respectively anolyte presence detector, in at least a part of the feed circuit of catholyte, respectively anolyte.

The present invention relates to the field of redox flow batteries comprising a stack of a plurality of electrochemical cells and using liquid electrolytes.

The present invention relates to a compact flow redox battery system incorporating electrolyte feed pumps and drainage pumps. The present invention further relates to a method implementing such a system and to an assembly comprising this system, the assembly being compact and/or having a constrained vertical space requirement.

### PRIOR ART

Flow batteries consist of a system which stacks electrochemical cells in series electrically and in parallel fluidically, to form a stack using electrolytes for storing energy. Such stack makes it possible to reach the voltage and power level required for the correct operation of the power converters. Energy is stored via a reversible electrochemical reaction within the electrochemical cells. The two electrolyte solutions are called anolyte and catholyte, respectively, and are stored in two separate tanks. During charging, the electrochemical reaction changes the ionic state of the electrolytes flowing within the stack and switches to a charged state. During the discharge, the reaction is reversible and the stored electrical energy is supplied to the “users”. In order to ensure the proper functioning of the system, electrolytes are continuously pumped through the stacks. The electrochemical reaction supplies direct current (DC) to the electrical circuit connected to bidirectional converters for charging and discharging alternating current (AC). The converters make possible the connection to the grid.

When shutting down the system, in order to eliminate any self-discharge phenomenon, it is necessary to make sure that the stacks are emptied of residual electrolytes and are isolated from the storage tanks. The self-discharge is due to a residual current in the stack, flowing through the electrolytes, thereby entailing a slow yet continuous discharge of the battery. The self-discharge could lead to a long-term loss of energy stored by the battery.

Currently, the methods conventionally used for overcoming such technical problems lie in the design of the stack frames so as to reduce the shunt current, as described e.g. by WO 2018095995 (KEMIWATT), or the placement of the tanks at a height making possible the emptying of the electrode compartments by gravity. Such flow battery systems of the prior art operate in an ON mode and an OFF mode. In the ON mode, a liquid anolyte and a liquid catholyte are made flow from the respective storage tanks into and through an electrochemical cell during which energy is drawn from the liquid anolyte and the liquid catholyte or stored in the two elements. To prevent a self-discharge of the flow battery system during a period when power is not drawn from the flow battery system or stored in the latter, the flow battery system switches from the ON mode to the OFF mode. In the OFF mode, the liquid anolyte and the liquid catholyte are emptied from the fuel cell into the respective storage tanks. In this way, the self-discharge of the flow battery system due to diffusion of electrochemically active species through an ion exchange membrane into the electrochemical cell, is prevented. A disadvantage of switching to the OFF mode is that if there is a demand for drawing or storing electrical energy in the flow battery system, the flow battery system of the prior art has a slow response. Thereby, EP2795709A1 describes a flow battery system operating with an ON mode, an OFF mode and a STANDBY mode. The system allows faster access to a portion of the full capacity of the flow battery system when same is not in the “ON” nor in the “OFF” mode. In STANDBY mode, a controller stops the pumps and closes the valves connecting the tanks to the fuel cell compartments. Thereby, the liquid anolyte and the liquid catholyte present in the electrochemical cell cannot flow back into the tanks. The portions of liquid anolyte and of liquid catholyte are stored for a period of time in the electrochemical cell, during which time no energy is drawn from the liquid anolyte and from liquid catholyte nor is stored.

Such systems need to be technically improved, more particularly in the context of compact flow batteries, available in the form of an all-in-one container comprising the electrochemical cell(s) and the electrolyte tanks.

### Goals of the Invention

The goal of the present invention is to provide a flow battery system for reducing the currents within the electrolytes, more particularly in electrochemical cells fluidically mounted in parallel and during the standby.

The goal of the present invention is to provide an electrochemical cell having a good service life, and more particularly improving the storage stability of the system by reducing the self-discharge phenomenon, in particular during standby phases.

The goal of the present invention is to provide a compact electrochemical cell and/or an assembly of electrochemical cells and storage tanks for the electrolytes flowing within the electrochemical cells, the assembly having e.g. to be placed in a constrained vertical environment.

The complexity of such technical problems is more particularly related to being able to solve all the problems together.

The goal of the present invention is to solve all such technical problems in a reliable, industrial and low-cost manner, and preferentially by providing a battery system with a compact flow and/or placed in a constrained vertical environment.

### DESCRIPTION OF THE INVENTION

The prior art cannot be used for solving such technical problems, more particularly within the framework of providing a system that is compact and/or placed or intended for being placed in a constrained vertical environment. Indeed, the prior solutions relate to systems comprising tanks, pumps and electrochemical cells with a large size. In the prior art techniques, the tanks are placed below the electrochemical cells so that the electrolytes are drained by gravity. Such geometry cannot be used for optimizing the volume and/or the efficiency and/or the cost within the framework of an integration of the flow batteries in a container, more particularly a container which is compact and/or placed or intended for being placed in a constrained vertical environment. Transport is also problematic for the prior techniques.

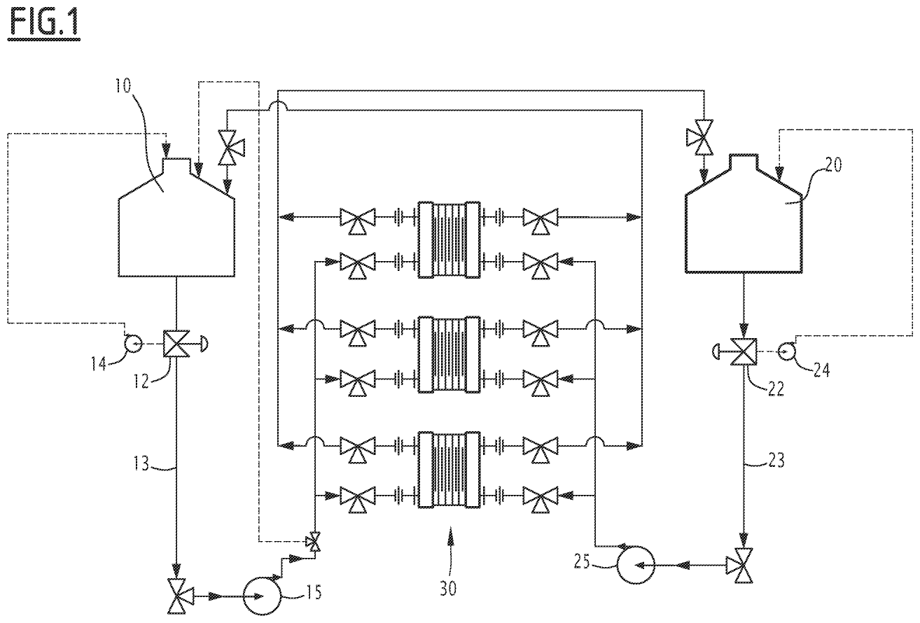

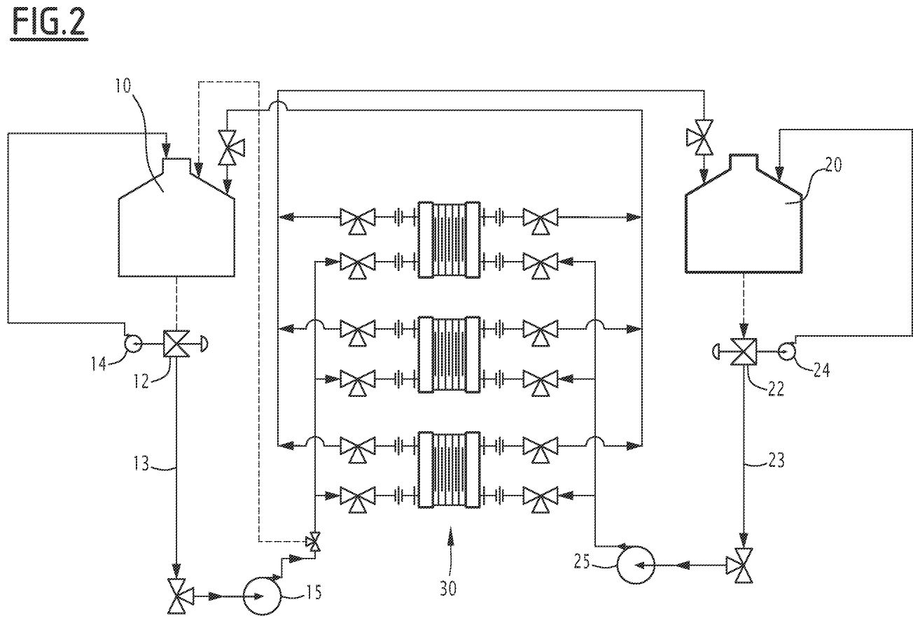

The present invention can be used for solving such technical problems, preferentially simultaneously. The references hereinafter are given as an illustration with regard to FIGS. 1 and 2, and thus the invention is in no way limited to same.

Thereby, the invention relates to a system comprising one or a plurality of redox flow batteries comprising a stack of a plurality of electrochemical cells 30, said electrochemical cells 30 comprising a cathode compartment and an anode compartment, the cathode compartment being in fluidic communication, via a feed circuit 13, with one or a plurality of tanks of electrolyte 10 called catholyte, the anode compartment being in fluidic communication, via a feed circuit 23, with one or a plurality of tanks 20 of electrolyte called anolyte, the feed circuit 13, 23 of the catholyte, respectively the anolyte, comprising a pump 15, 25 for circulating the catholyte, respectively the anolyte, from the tank 10, 20 to the cathode, respectively the anode compartments, said system comprising a catholyte drainage pump 14 and an anolyte drainage pump 24, the catholyte, respectively the anolyte drainage pump being controlled by a catholyte, respectively anolyte presence detector, in at least a part of said feed circuit 13, 23 catholyte, respectively anolyte, the feed circuit 13, 23 of catholyte or anolyte comprising a device 12, 22 either letting or not letting circulate the catholyte, respectively the anolyte, from the tank 10, 20 of catholyte, respectively anolyte, to the cathode, respectively anolyte compartments.

According to a variant, the circulation authorization device 12, 22 is a three-way solenoid valve connecting either the tank 10, 20 to the circulation pump 15, 25, or connecting the electrochemical cells 30 to the drainage pump 14, 24.

According to a variant, said drainage pump 14, 24 is positioned on a circuit at least in part dedicated to the drainage of the catholyte, respectively the anolyte, called drainage circuit.

Typically, each drainage pump of the catholyte, respectively of the anolyte, is independently controlled by one or a plurality of electrolyte presence sensors.

According to a variant, said circulation pump 15, 25 is positioned on a circuit at least in part dedicated to the circulation of the catholyte, respectively the anolyte, towards the electrochemical cells, called feed circuit 13, 23.

Typically, said measuring device is a device for measuring the liquid level of the catholyte, respectively of the anolyte, in at least a part of said feed circuit and/or of cathode, respectively anode compartments.

Advantageously, when the measuring device detects the presence of the catholyte, respectively the anolyte, the drainage pump for the catholyte, respectively the anolyte, is in operation and the catholyte, respectively the anolyte, circulates through the drainage circuit of the catholyte, respectively the anolyte, and feeds the inlet of the tank of catholyte, respectively of anolyte.

The invention further relates to a method for producing electricity using one or a plurality of redox flow batteries comprising a stack of a plurality of electrochemical cells, said electrochemical cells comprising a cathode compartment and an anode compartment, the cathode compartment being in fluidic communication via a feed circuit with one or a plurality of tanks of electrolyte called catholyte, the anode compartment being in fluidic communication via a feed circuit with one or a plurality of tanks of electrolyte called anolyte, the feed circuit of the catholyte, respectively the anolyte, comprising a pump for circulating the catholyte, respectively the anolyte from the tank to the cathode, respectively anode compartments, said system comprising a catholyte drainage pump and an anolyte drainage pump, the drainage pump for the catholyte, respectively the anolyte, being controlled by a device for measuring the presence of catholyte or anolyte in at least a part of said catholyte or anolyte feed circuit, said drainage pump being in operation when the presence of catholyte or anolyte is detected by the measuring device, the feed circuit of the catholyte, respectively the anolyte, comprising a device for either letting or not letting circulate the catholyte, respectively the anolyte, from the tank of catholyte, respectively of anolyte, to the cathode, respectively anode compartments.

Advantageously, in the charging or discharging mode of the flow batteries, the catholyte, respectively the anolyte, circulates from the catholyte, respectively the anolyte tank, to the cathode, respectively anode compartments, and advantageously, in the standby mode of the flow batteries, the catholyte, respectively the anolyte, is drained from the feed circuit of the catholyte, respectively of the anolyte, and/or cathode, respectively anode compartments, to the catholyte, respectively anolyte tank.

According to a variant, in the charging or discharging mode of the flow batteries, the catholyte, respectively the anolyte, circulates from the outlet of the catholyte, respectively the anolyte tank, to the cathode, respectively anode compartments, and then to the inlet of the catholyte, respectively the anolyte tank, and in the standby mode of flow batteries, the catholyte, respectively the anolyte, circulates from the feed circuit of the catholyte, respectively the anolyte, and/or from the cathode, respectively the anode compartments, to a zone near the inlet of the catholyte, respectively the anolyte tank.

According to a variant, in the standby mode of the flow batteries, drainage is activated when the measuring device detects the presence, e.g. by measuring the liquid level, of catholyte, respectively of anolyte in at least a part of said feed circuit and/or of cathode, respectively anode compartments.

The invention further relates to a compact set of electrochemical cells, comprising in a container, a system as defined according to the invention or a system implementing a method according to the invention.

Advantageously, the compact set of electrochemical cells can be transported.

Thereby, advantageously, the invention consists of carrying out the drainage of the stacks in a mechanical way so as not to depend on gravity, more particularly in a compact system and/or placed or intended for being placed in a constrained vertical environment, preferentially transportable.

Thereby, according to one embodiment, in charge/discharge mode, a three-way solenoid valve is positioned for feeding the feed circuit thereby directing the electrolytes towards the stacks of electrochemical cells. The above is a completely conventional operation of a flow battery. According to one embodiment, in standby mode, the three-way solenoid valve is positioned for feeding the drainage circuit. According to the standby embodiment, when a level sensor detects electrolytes in a line of the feed circuit in the fuel cells, the drainage pump is turned on for directing the electrolyte or electrolytes concerned to the storage tanks. According to the standby embodiment, when a level sensor does not detect the presence of electrolytes, the drainage pump is stopped.

In the present description, reference is made indifferently to electrolytes, more particularly to the catholyte or to the anolyte. The circuits of each electrolyte are independent in the sense that the circuits do not communicate, in particular in order to physically separate the catholyte from the anolyte. Thereby, the feed pumps and the drainage pumps, the electrolyte tanks and the cathode, respectively anode compartments, can work independently. Thereby, each embodiment of the catholyte feed and/or drainage circuit can be independent of the anolyte feed and/or drainage circuit, in the structure and/or operation thereof. However, according to one embodiment, the structures and functioning of the circulation and/or drainage of the catholyte and the anolyte can be coupled.

The invention will be described more precisely in relation to the figures, without limiting the scope of the invention. In the present invention, reference is made independently to the different elements by the reference numbers thereof in the figures, without any limitation of the scope of the invention. References to an element with multiple reference numbers mean that the description generally applies to the element bearing the reference sign. Thereby e.g. a reference to the tank 10, 20 means that the description applies generally and independently or simultaneously to the tank 10 and to the tank 20.

FIG. 1 schematically shows an embodiment working in the ON mode.

The system comprises catholyte tank 10 and an anolyte tank 20. The catholyte tank is in fluidic communication, via a feed system 13, with the cathode compartments of a plurality of electrochemical cells 30. The anolyte tank 20 is in fluidic communication, via a feed system 23, with the anodic compartments of a plurality of electrochemical cells 30. The feed system 13 for the catholyte comprises a feed pump 15 and a device for letting the fluid through, e.g. a three-way solenoid valve 12, directing the catholyte from the tank 10 to the electrochemical cells 30 in charge/discharge operating mode. The anolyte feed system 23 comprises a feed pump 25 and a device for letting the fluid through, e.g. a three-way solenoid valve 22, directing the anolyte from the tank 20 to the electrochemical cells 30 in charge/discharge operating mode. Said mode makes it possible to feed the stacks (plurality of electrochemical cells 30) with electrolyte thus leading to the normal operation of the battery in charge and discharge mode.

FIG. 2 schematically illustrates an embodiment working in standby mode. In standby mode, the outlet solenoid valves 12, 22 of the tanks rotate independently so as to isolate the tanks 10, 20, respectively. The solenoid valve 12, 22 rotates so as to bring the catholyte, respectively the anolyte, into contact with a drainage pump 14, 24, respectively. The feed of the drainage pump 14, 24 is connected to one or a plurality of detectors of the presence of the electrolyte in question, e.g. one or a plurality of detectors of liquid level. The electrolyte presence detector(s) can typically be positioned between the solenoid valve 12, 22 and the feed pump 15, 25, respectively. In general, each drainage pump 14, 24 can be independently servo-controlled by one or a plurality of sensors for the presence of electrolyte. When the detector detects the presence of residual electrolyte in a feed circuit, the detector sends a signal, typically via a Battery Management System (BMS, not shown in the figures), to supply the drainage pumps 14, 24 so as to substantially empty the feed circuits 13, 23, respectively and the stacks 30, of residual electrolytes. Such system makes possible to not have to position the stacks 30 above the tanks 10, 20 for ensuring a drainage and an isolation of the stacks 30, which reduces the self-discharge of the flow battery, more particularly when the container is compact and/or placed or intended for being placed in a constrained vertical environment.

Typically, the containers are 20 feet, 20 feet HO (High Cube), or 40 feet containers. More generally, a container or an environment constrained in height can be concerned. Thereby, such a constrained environment does not allow the electrolyte tanks to be positioned freely, and more particularly below the level of the electrochemical cells.

Typically, according to the invention, the positioning in space of the electrolyte tanks with respect to the electrochemical cells does not make possible a liquid drainage by gravity of the catholyte, respectively of the anolyte, contained in the electrochemical cells.

Advantageously, according to the invention, the electrolyte tanks are positioned below the liquid level of catholyte, respectively anolyte, contained in the electrochemical cells.

Experiments were carried out. According to a system of the prior art, without the implementation of a drainage servo-controlled by an electrolyte presence detector and the fluidic isolation of the electrolytes, a loss of 420 Ah is observed. With a system according to the present invention, including a drainage circuit servo-controlled by an electrolyte presence detector, and isolated, reduces the loss to 234 Ah. The inventors were thus able to improve the storage stability of the redox flow battery system by reducing the self-discharge phenomenon during the standby phases.

System or process “according to the invention” or equivalent terms means a system or a method as defined in the present invention, including according to any of the variants, particular or specific embodiments, independently or according to any of the combinations thereof, even according to the preferred features.

Other goals, features and advantages of the invention will become clear to a person skilled in the art from reading the explanatory description which refers to the figures which are given only as an illustration and which do not, in any way, limit the scope of the invention.

1. A system comprising one or a plurality of redox flow batteries comprising a stack of a plurality of electrochemical cells, said electrochemical cells comprising a cathode compartment and an anode compartment, the cathode compartment being in fluidic communication via a feed circuit with one or a plurality of tanks of electrolyte called catholyte, the anode compartment being in fluidic communication via a feed circuit with one or a plurality of tanks of electrolyte called anolyte, the feed circuit of the catholyte, respectively of the anolyte, comprising a circulation pump of the catholyte, respectively of the anolyte, from the tank to the cathodic or anodic compartments, said system comprising a catholyte drainage pump and an anolyte drainage pump, the catholyte, respectively anolyte drainage pump being servo-controlled by a presence detector for detecting the presence of catholyte, respectively of anolyte in at least part of said feed circuit of catholyte, respectively of anolyte, the feed circuit of the catholyte, respectively the anolyte, comprising a circulation authorization device for either letting or not letting circulate the catholyte, respectively the anolyte, from the catholyte, respectively the anolyte tank, to the cathode, respectively anode compartments.

2. The system according to claim 1, wherein the circulation authorization device is a three-way solenoid valve connecting either the tank to the circulation pump or connecting the electrochemical cells to the drainage pump.

3. The system according to claim 1, wherein said drainage pump is positioned on a circuit at least in part dedicated to the drainage of the catholyte, respectively the anolyte, called drainage circuit.

4. The system according to claim 1, wherein said circulation pump is positioned on a circuit at least in part dedicated to the circulation of the catholyte, respectively the anolyte, towards the electrochemical cells, called the feed circuit.

5. The system according to claim 1, wherein said catholyte, respectively anolyte presence detector is a device for measuring the liquid level of the catholyte, respectively the anolyte, in at least a part of said feed circuit and/or cathode, respectively anode compartments.

6. The system according to claim 1, wherein, when the presence detector detects the presence of the catholyte, respectively the anolyte, the drainage pump for the catholyte, respectively the anolyte, is in operation and the catholyte, respectively the anolyte circulates in the drainage circuit of the catholyte, respectively of the anolyte, and feeds the inlet of the tank of the catholyte, respectively of the anolyte.

7. A method for producing electricity using one or a plurality of redox flow batteries comprising a stack of a plurality of electrochemical cells, said electrochemical cells comprising a cathode compartment and an anode compartment, the cathode compartment being in fluidic communication via a feed circuit with one or a plurality of tanks of electrolyte called catholyte, the anode compartment being in fluidic communication via a feed circuit with one or a plurality of tanks of electrolyte called anolyte, the feed circuit of the catholyte, respectively the anolyte, comprising a pump for circulating the catholyte, respectively the anolyte from the tank to the cathode, respectively anode compartments, said system comprising a catholyte drainage pump and an anolyte drainage pump, the drainage pump for the catholyte, respectively the anolyte, being servo-controlled by a measuring device for measuring the presence of catholyte or anolyte in at least a part of said catholyte or anolyte feed circuit, said drainage pump being in operation when the presence of catholyte or anolyte is detected by the measuring device, the feed circuit of the catholyte, respectively the anolyte, comprising an authorization device for either letting or not letting circulate the catholyte, respectively the anolyte, from the tank of catholyte, respectively of anolyte, to the cathode, respectively anode compartments.

8. The method according to claim 7, wherein the charging or discharging mode of the flow batteries, the catholyte, respectively the anolyte flows from the catholyte, respectively the anolyte tank to the cathode, respectively the anode compartments, and in that in the standby mode of the flow batteries, the catholyte, respectively the anolyte, is drained from the feed circuit of the catholyte, respectively of the anolyte, and/or from the cathode, respectively anode compartments, to the catholyte, respectively the anolyte tank.

9. The method according to claim 7, wherein, in the charging or discharging mode of the flow batteries, the catholyte, respectively the anolyte flows from the outlet of the catholyte, respectively the anolyte tank to the cathode, respectively the anode compartments and then to the inlet of the catholyte, respectively the anolyte tank, and in that in the standby mode of the flow batteries, the catholyte, respectively the anolyte, flows from the feed circuit of the catholyte, respectively the anolyte, and/or from the cathode, respectively the anode compartments, to a zone near the inlet of the catholyte, respectively the anolyte tank.

10. The method according to claim 7, wherein in the standby mode of the flow batteries, drainage is activated when the measuring device detects the presence of catholyte, respectively of anolyte, for example by measuring the liquid level, in at least a part of said feed circuit and/or a part of said cathode, respectively anode compartments.

11. A compact electrochemical cell assembly, comprising in a container the system of claim 1.

12. The assembly according to claim 11, characterized in that it can be transported.
